(19) United States
(12) Patent Application Publication
(10) Pub. No.: US 2013/0166416 A1
(43) Pub. Date: Jun. 27, 2013

(54) DYNAMIC CATALOGS ON MOBILE WIRELESS DEVICES

(71) Applicant: Peter Eberlein, Malsch (DE)

(72) Inventor: Peter Eberlein, Malsch (DE)

(21) Appl. No.: 13/333,976

(22) Filed: Dec. 21, 2011

(51) Int. Cl. G06Q 30/06

(52) U.S. Cl. 705/27.1

(57) ABSTRACT

Methods and apparatus, including computer program products, are provided generating catalogs for use on a mobile wireless device. The method may include receiving, from a mobile wireless device, information including at least one filter and at least one filter value, wherein the at least one filter and the at least one filter value are selected at the mobile wireless device; generating a catalog by at least filtering, based on at least the received information, one or more items for the catalog; and presenting the generated catalog. Related apparatus, systems, methods, and articles are also described.

### FIELD

The subject matter described herein relates to generating electronic catalogs.

### BACKGROUND

Purchasing products from catalogs available in electronic form on the Internet has become commonplace today. Almost every type of website has products for sale in an electronic product catalog. For example, retailers may provide catalogs of products for sale. For example, a home improvement store may have an electronic catalog of home appliances, which would likely include appliances such as vacuums, stoves, refrigerators, and the like, that can be purchased over the Internet. Other examples include electronic catalogs of women's clothing, men's clothing, and kids clothing. Users can select items that they wish to purchase from the catalog, pay for the items, and enter shipping information, as needed.

### SUMMARY

Methods and apparatus, including computer program products, are provided for generating electronic product catalogs. For some example implementations, there is provided a method. The method may include receiving, at a mobile wireless device, information including at least one filter and at least one filter value, wherein the at least one filter and the at least one filter value are selected at the mobile wireless device; generating a catalog by at least filtering, based on at least the received information, one or more items for the catalog; and presenting the generated catalog.

In some implementations, the above-noted aspects may further include additional features described herein including one or more of the following. A query of a database may be generated based on the at least one filter and the at least one filter value, wherein the database may include the one or more items for the catalog. The query may filter the one or more items for the catalog based on the at least one filter and the at least one filter value. The query may filter the one or more items for the catalog based on a first filter representative of recently ordered items. The catalog may be generated dynamically based on the at least one filter and the at least one filter value received at the mobile wireless device. The at least one filter may comprise one or more of an account ID, a base catalog, a time frame, and a number of orders. The metadata may be received to enable generation of the catalog as at least one of a plurality of pages. The mobile wireless device may send the received information to a server that generates the dynamic catalog. The received information may be provided by a user interface. The received information may be provided based on an identity a customer.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts a simplified functional block diagram of an exemplary system in accordance with some exemplary implementations;

FIG. 2 depicts an example of a page presented at a user interface in accordance with some exemplary implementations;

FIG. 3 depicts another example of a page for configuring a catalog in accordance with some exemplary implementations;

FIG. 4 depicts examples of database elements used in the creation of a catalog in accordance with some exemplary implementations;

FIG. 5 depicts an example of a process for generating a catalog in accordance with some exemplary implementations; and

FIG. 6 depicts an example of a process for presenting a catalog in accordance with some exemplary implementations.

Like labels are used to refer to same or similar items in the drawings.

### DETAILED DESCRIPTION

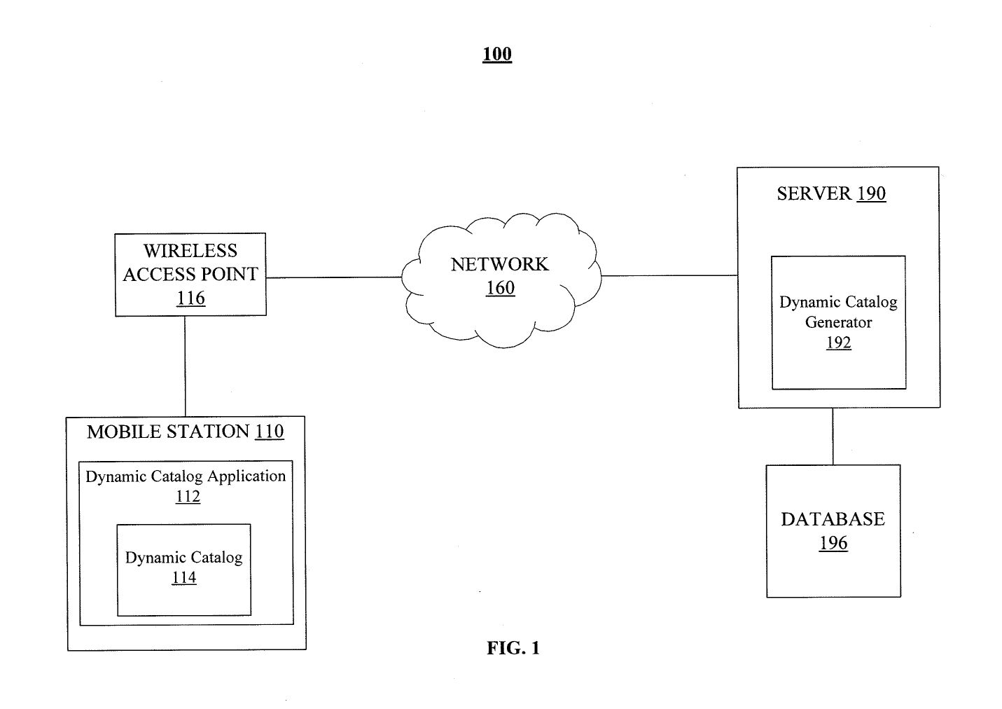

FIG. 1 depicts a system 100 for generating a catalog in accordance with some exemplary implementations. The system 100 may include at least one server, such as for example server 190, coupled to a network, such as network 160, which in turn is coupled to mobile station 110 via wireless access point 116. The server 190 may further include a dynamic catalog generator 192 for generating catalogs and may be coupled to database 196, where catalog related information may be stored. For example, the catalog related information may include one or more of the following: a plurality of items which may be queried for inclusion in a catalog, pricing for the plurality of items, availability of the plurality of items, past orders for the plurality of items, pending orders for the plurality of items, and the like. The mobile station 110 may further include a dynamic catalog application 112 for presenting one or more pages depicting dynamic catalog 114.

In some implementations, the dynamic catalog generator 192 may perform one or more of the following: receive from dynamic catalog application 112 information, such as filters, filter values, and the like; query, based on the filters and/or filter values, the database for items for inclusion in the dynamic catalog 114; generate the dynamic catalog 114 (and/or pages depicting some, if not all, of the dynamic catalog 114); and/or send dynamic catalog 114 (e.g., as pages and/or metadata to allow dynamic catalog application 112 to generate pages to present at mobile station 110). The one or more pages depicting the items of the dynamic catalog 114 may be configured as hyper text markup language pages, although other types of pages may be used as well.

In some implementations, dynamic catalog generator 192 is included in dynamic catalog application 112. Dynamic catalog application 112 may retrieve the base catalogs from server 190 and performs the dynamic catalog generation locally in dynamic catalog application 112 at the mobile station 110.

The catalog (also referred to herein as dynamic catalog) is a catalog including a plurality of items (e.g., services, products, and the like), and the items included in the catalog are obtained based on at least a filter and a corresponding value associated with the filter. For example, the filter may be a time frame, and the filter value may be 4 weeks. In this example, dynamic catalog generator 192 may generate dynamic catalog 114 to include items ordered by others in the last 4 weeks and then send the generated catalog 114 as metadata and/or one or more pages to dynamic catalog application 112 at mobile station 110 for presentation at a user interface of mobile station 110. In some implementations, the filters may be configured by selecting a given customer (e.g. logging into a customer account). For example, the filter values for a particular customer may be associated with that customer and are retrieved from the customer information without input from the user. For example, a first filter may select a given customer and a second filter may select items ordered over a given time frame, such as the past 4 weeks. In this example, a user, such as a sales person/customer, will view at mobile station 110 a dynamic catalog 114 including items ordered by the given client in the last 4 week. In some implementations, the filter values are configured by the user when a dynamic catalog is first generated. For example, the user may input a customer name for the first filter, and a desired time frame for the second filter and generate a dynamic catalog based on the inputs. The inputs may be saved as part of the dynamic catalog associated with the customer. The next time a user selects that customer, the filter values from the previously generated dynamic catalog may be used.

The dynamic catalog application 112 may perform one or more of the following: present a selection page enabling selection of one or more filters, filter values and the like used to generate the dynamic catalog 114; send from dynamic catalog application 112 to dynamic catalog generator 192 information, such as filters, filter values, and the like; receive the dynamic catalog 114 (and/or pages depicting some, if not all, of the dynamic catalog 114); present the dynamic catalog 114 (e.g., as pages, and the like); generate dynamic catalog 114. In some implementations, the dynamic catalog application 112 may also generate pages depicting items of dynamic catalog 114 based on metadata sent by dynamic catalog generator 192 or dynamic catalog 114 generated at catalog application 112.

In some implementations, a page including one or more items of the dynamic catalog 114 may be presented by dynamic catalog application 112 at a user interface at the mobile station 110. The dynamic catalog application 112 may include a web browser, a thin client, and/or any other mechanisms for presenting the dynamic catalog 114 including pages depicting some of the dynamic catalog 114.

Network 160 may include any type of wired network, wireless network, or combination of the two. For example, network 160 may comprise one or more of the following: a public switched telephone network (PSTN), the Internet, a public land mobile network (PLMN), and the like.

The wireless access point 116 may provide wireless access to a public land mobile network and/or a wireless local area network. For example, the wireless access point 116 may be implemented as a cellular base station of a public land mobile network and/or as a wireless access device (e.g., a Wi-Fi wireless access point) providing access to a wireless network.

Server 190 may comprise a computer system with a wired or wireless interface to network 160 and in some implementations an interface to database 196. The computer system may comprise at least one processor, at least one memory, at least one memory, and the like. In some implementations, the server may be configured on a virtual machine hosted on a physical processor(s).

The mobile station 110 may be implemented as a mobile wireless device, although at any given time the mobile station may be stationary. The mobile station may be referred to as, for example, devices, user equipment, mobile units, subscriber stations, wireless terminals, terminals, tablets, netbook computer, laptop computer and/or any other wireless device. Moreover, the mobile station may also be implemented as, for example, a wireless handheld device, a wireless plug-in accessory, or the like. For example, the mobile station may take the form of a wireless phone, a computer with a wireless connection to a network, or the like. In some instances, the mobile station may include one or more of the following: at least one processor, at least one computer-readable storage medium (e.g., memory, storage, and the like), at least one user interface, and at least one radio access mechanism.

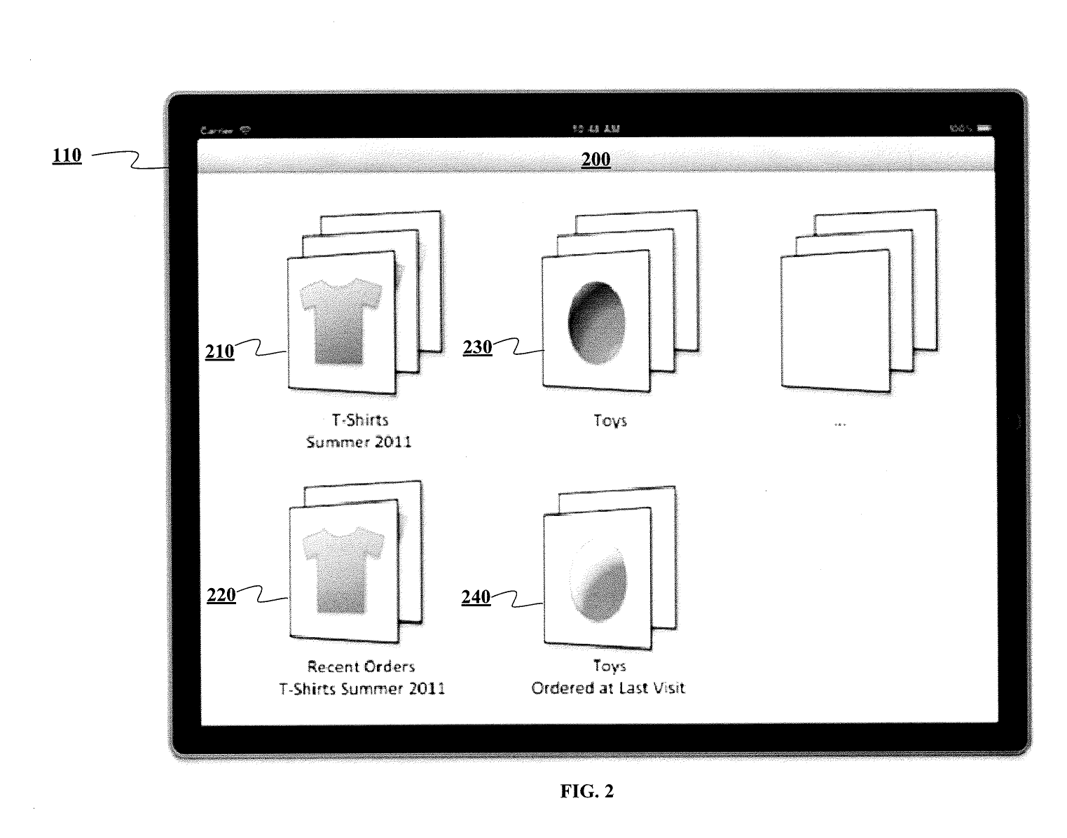

FIG. 2 depicts a page 200 presented at a user interface of mobile station 110. The page 200 includes one or more dynamic catalogs, such as catalogs 210, 220, 230, and 240. The dynamic catalogs are catalogs generated based on at least one filter and values for those filters. Moreover, the catalog may be considered dynamic in the sense that the catalog is formed based on at least one filter and at least one filter value, which can be selected at mobile station 110. As such, the dynamic catalog may be formed on the so-called “fly” from all of the available items in database 196 based on the filters/filter values.

For example, a salesperson may select a first filter for a specific customer and a second filter to see what T-shirts were ordered by that specific customer. The dynamic catalog in this example corresponds to catalog 210. The sales person may use a third filter, such as recent orders (e.g., orders over a specific time frame), and the dynamic catalog generated and delivered to mobile station 110 would correspond to catalog 220. The salesperson may then go to another customer and select a first filter for the other customer and a second filter to select items corresponding to toys, and the generated dynamic catalog in this example would correspond to catalog 230. The sales person may use a third filter, such as toys ordered at the last visit (e.g., over a specific time frame), and the dynamic catalog generated and delivered to mobile station 110 would correspond to catalog 240. The dynamic catalogs, such as catalogs 210, 220, 230, and 240, represent items that are filtered (e.g., queried, selected, and the like) based on the filters and/or filter values. This filtering is described further below.

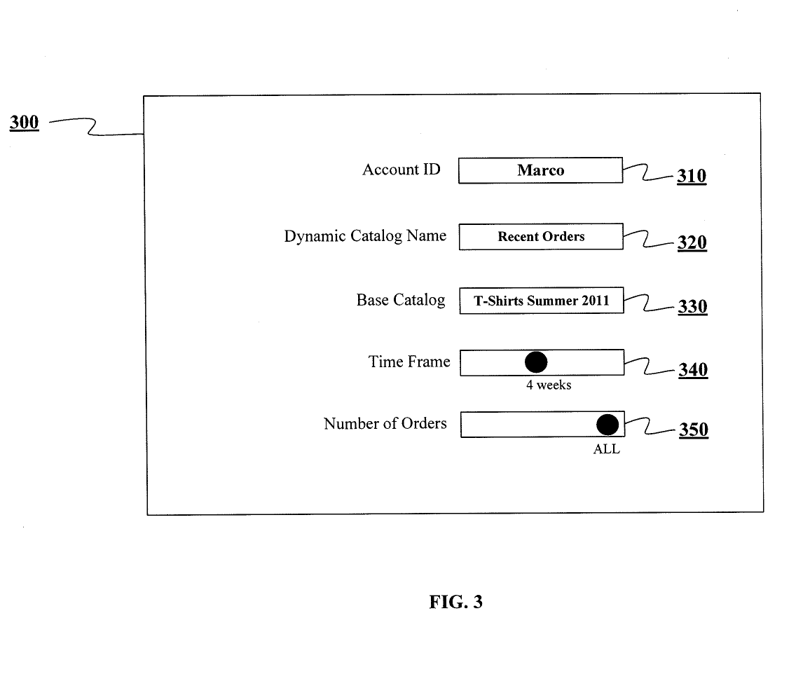

FIG. 3 depicts an example of a page 300 presented at dynamic application catalog 112. The page 300 may be used for selecting one or more filters and their corresponding values. Moreover, this selection may configure the generation of a dynamic catalog at dynamic catalog generator 192. In the example of FIG. 3, the filters include a filter for the account ID 310, a filter for the dynamic catalog name 320, a filter for the base catalog 330, a filter for the time frame 340, and a filter for the number of orders 350. Each filter has a filter value associated with it. In the example shown in FIG. 3, the filter “Account ID” has possible values of “Filter by Current Account,” and “No Filtering by Account.” 310 shows filtering by current account “Marco” as selected to enable selection of items in database 196 based on customer “Marco.” The filter dynamic catalog name 320 may enable filtering items in database 196 based on a name; the filter “Base Catalog” may enable filtering database 196 for items based on a catalog name (or predetermined base catalog); the filter “Time Frame” may be used to filter items in database 196 based on when an item was last ordered (e.g., “4 weeks”); and the filter “Number of Orders” may be used to filter items in database 196 based on how many orders have been placed. In some implementations, the dynamic catalog name 320 is just the name of the dynamic catalog that is generated. In some implementations, once a dynamic catalog is generated with dynamic catalog name 320, the catalog name can later be used as a filter. In this example, a dynamic catalog is generated with a “Dynamic Catalog Name” of “Recent Orders.” The selected filters and filter values applied to database 196 result in a query for items from the dynamic catalog. Other filters are possible. Additional examples include: price range, available within a time frame (e.g. now, one week, etc), and product attributes (e.g. color, size, etc), just to name a few.

The values shown in FIG. 3 configure the generation of a dynamic catalog named “Recent Orders” to include products associated with customer “Marco,” base catalog “T-Shirts Summer 2011,” time frame “4 weeks,” and number of orders “All.” For example, a user, such as a salesperson, customer, and the like, may enter information at page 300 presented at mobile station 110 to allow selection of the filter and its values. Once the filters and filter values are selected, the filter and/or filter values are provided by the dynamic catalog application 112 to the dynamic catalog generator 192, where the filters and/or filter values are applied to the database 196 (e.g., the filters may be used to generate queries for catalog items at database 196).

To further illustrate the filters described herein, filtering by account ID is performed by selecting a customer account, and selecting “Filter by Current Account,” in the account ID at 310. The filter value may be sent as a message to dynamic catalog generator 192, where a structured query language (SQL) query is generated and sent to database 196 to obtain items for the dynamic catalog. The SQL query may take the following form:

$products=SELECT*FROM Product WHERE ANY Product.Catalog.ID=$catalog_id AND ANY Order_Items.Sales_Order.Account.ID=$account_id (1)

Filtering based on a time frame of recent orders is performed by entering a value for the time frame 340. The filter value may be sent as a message to dynamic catalog generator 192, where a structured query language (SQL) query is generated and sent to database 196 to obtain items for the dynamic catalog. The SQL query may take the following form:

$products=SELECT*FROM Product WHERE ANY Product.Catalog.ID=$catalog_id AND ANY Order_Items.Sales_Order.Date>=$order_date (2)

Filtering based on a number of orders 350 may be performed in two steps. First, identify the sales orders that occurred within the time frame specified number of orders 350. Second, fetch the products from these orders from the specified base catalog 330. The SQL queries may take the following form:

$sales_orders=SELECT Related_Documents from Activity where Account.ID=$account_id and Type=‘Customer_Visit’ ORDER BY Date DESCENDING MAXITEMS=$number_of_visits. (3)

$products=SELECT*from Product WHERE ANY Product.Catalog.ID=$catalog_id AND ANY Order_items.Sales_Order IN $sales_orders (4)

Filters may be combined to produce dynamic catalogs satisfying any number of filters and filter values. Moreover, the filters at (1)-(4) are only examples as other filters and/or commands (e.g., a JOIN, and the like) may be used as well.

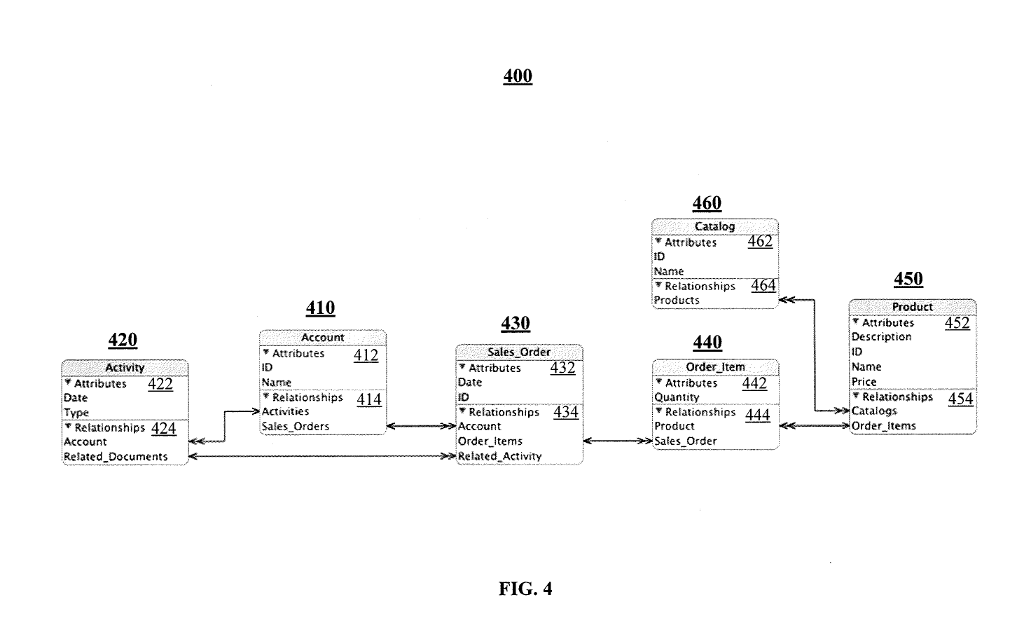

FIG. 4 depicts database elements 400, which may be used at database 196. The database elements may be used in the creation of a dynamic catalog including account 410, activity 420, sales order 430, order item 440, product 450, and catalog 460. Any combination of the database elements 400 may be stored in database 196 and/or used as filters having filter values to generate a dynamic catalog. Each database element shown has associated attributes 412, 422, 432, 442, 452, 462 and corresponding relationships 414, 424, 434, 454, 464. For example, dynamic catalog generator 192 may query (based on filters and/or filter values selected at mobile station 110) database 196 for any combination of database elements 400 for items used to form the dynamic catalog.

In some implementations, filtering the database elements 400 may include one or more of filtering by Account 410 to filter by account ID and/or account name, filtering by Activity 420 to filter by activity date, activity type, and/or number of recent visits, and filtering by Sales_Order 430 to filter by the order date of a sales order for an item in database 196. Catalog 460, Products 450, and Order_Item 440 are data items that are filtered to generate items for the dynamic catalog. The filters, filter names, values, and relationships among the elements 400 in FIG. 4 are merely examples as other filters, filter names, values, and relationships may be used as well.

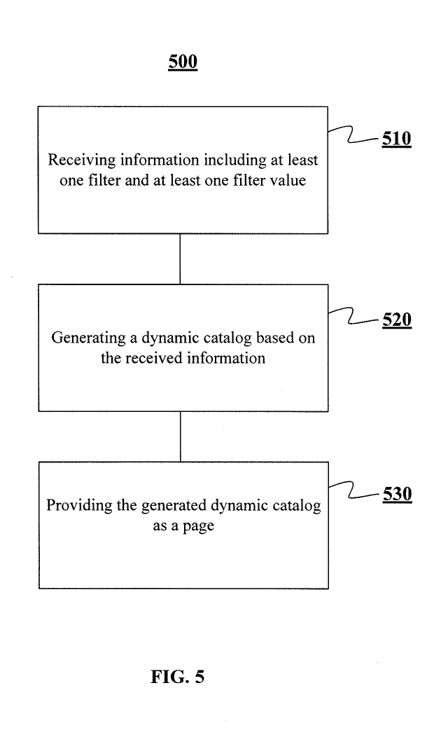

FIG. 5 depicts a process 500 for generating a dynamic catalog. The description of FIG. 5 also refers to FIGS. 1, 2, and 3.

At 510, information including a filter and a filter value may be received. For example, when a selection is made at page 200, the selected filters and corresponding filter values are sent from the dynamic catalog application 112 at mobile station 110 to dynamic catalog generator 192 at server 190. Once received, the dynamic catalog generator 192 may use the received information to generate a dynamic catalog. For example, the received information may be used to generate queries for items at database 196. Examples of filters and filter values that may be received at 510 include but are not limited to the filters and filter values shown in FIG. 3 including account ID 310 filter and filter value “Marco,” base catalog 330 filter and filter value “T-Shirts Summer 2011,” time frame 340 filter and filter value “4 weeks,” and number of orders 350 filter with filter value “All.”

At 520, a dynamic catalog may be generated based on the information received at 510. For example, the dynamic catalog generator 192 may generate a dynamic catalog 114 by applying the at least one filter and at least one filter value received at 510 to data obtained from database 196. Specifically, one or more filters including one or more filter values may be used to obtain the information that will comprise the dynamic catalog 114. These filters and filter values may be used in the query of database 196 for the dynamic catalog 114 information. For example, if the filter received at 510 corresponds to time frame of 4 weeks, dynamic catalog generator 192 may form an SQL query in accordance with SQL query (2) to query database 196, although any other type of filter and/or filter value may be used as well. In response to the query, the dynamic catalog generator 192 may receive information including items comprising the dynamic catalog 114.

At 530, the dynamic catalog may be provided as a page to an application on a mobile station. For example, the dynamic catalog formed at 192 may then be provided to mobile station 110 as dynamic catalog 114. Moreover, the dynamic catalog generator 192 may provide dynamic catalog 114 as one or more pages to dynamic catalog application 112 at mobile station 110, or dynamic catalog generator 192 may provide the dynamic catalog 114 as metadata (e.g., information representative of the dynamic catalog 114 including the items therein) to dynamic catalog application 112 at mobile station 110. In any case, dynamic catalog application 112 presents the dynamic catalog 114 generated based on at least one filter and at least one filter value.

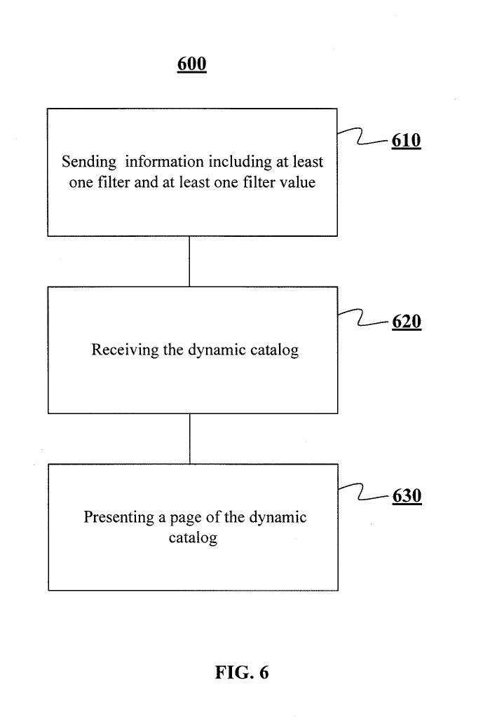

FIG. 6 depicts a process 600 for presenting a dynamic catalog at a mobile station. The description of FIG. 6 also refers to FIGS. 1, 2, and 3.

At 610, information including a filter and a filter parameter may be sent. For example, when a selection is made at page 200, the selected filters and corresponding filter values are sent from the mobile station 110 to dynamic catalog generator 192.

At 620, the mobile station receives the dynamic catalog. For example, mobile station 110 may receive from dynamic catalog generator 192 the dynamic catalog 114. The dynamic catalog 114 may be received as one or more pages including the filtered items of the catalog 114, or as metadata from which dynamic catalog application 112 may form pages of dynamic catalog 114.

At 630, at least one page of the dynamic catalog is presented. For example, dynamic product application 112 may present dynamic catalog 114 as at least one page, such as for example page 200. When selected, the dynamic catalog 114 is selected and/or browsed at the user interface of mobile station 110, the presented pages may depict one or more items of dynamic catalog 114 filtered in accordance with the selection made at for example page 300. In some implementations, the filters and filter values may cause the dynamic catalog 114 to include items recently ordered by a given customer, which may facilitate ordering by that customer.

The subject matter described herein may be embodied in systems, apparatus, methods, and/or articles depending on the desired configuration. For example, the mobile station (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “machine-readable medium” refers to any computer program product, computer-readable medium, apparatus and/or device (e.g., magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. In various example implementations, the methods (or processes) can be accomplished on mobile station/mobile device side or on the server side or in any shared way between server and user equipment/mobile device with actions being performed on both sides. The phrases “based on” and “based on at least” are used interchangeably herein. Other implementations may be within the scope of the following claims.

What is claimed:

1. A method comprising:
receiving, at a mobile wireless device, information including at least one filter and at least one filter value, wherein the at least one filter and the at least one filter value are selected at the mobile wireless device;
generating a catalog by at least filtering, based on at least the received information, one or more items for the catalog; and
presenting the generated catalog.

2. The method of claim 1, wherein the receiving further comprises:
receiving the information at the mobile wireless device to enable a query of a database including the one or more items for the catalog.

3. The method of claim 1, wherein the generating further comprises:
generating, based on the at least one filter and the at least one filter value, a query of a database, the database including the one or more items for the catalog.

4. The method of claim 3, wherein the query filters the one or more items for the catalog based on the at least one filter and the at least one filter value.

5. The method of claim 3, wherein the query filters the one or more items for the catalog based on a first filter representative of recently ordered items.

6. The method of claim 1, wherein the generating further comprises:
generating the catalog dynamically based on the at least one filter and the at least one filter value received at the mobile wireless device.

7. The method of claim 1, wherein the at least one filter comprises one or more of an account ID, a base catalog, a time frame, and a number of orders.

8. The method of claim 1, further comprising:
receiving metadata to enable generation of the catalog as at least one of a plurality of pages.

9. The method of claim 1, wherein the received information is provided by a user interface.

10. The method of claim 1, wherein the received information is provided based on an identity a customer.

11. A non-transitory computer readable medium containing executable instructions, that when executed by at least one processor perform operations comprising:
receiving, at a mobile wireless device, information including at least one filter and at least one filter value, wherein the at least one filter and the at least one filter value are selected at the mobile wireless device;
generating a catalog by at least filtering, based on at least the received information, one or more items for the catalog; and
presenting the generated catalog.

12. The non-transitory computer readable medium of claim 11, wherein the generating further comprises:
generating, based on the at least one filter and the at least one filter value, a query of a database, the database including the one or more items for the catalog.

13. The non-transitory computer readable medium of claim 12, wherein the query filters the one or more items for the catalog based on the at least one filter and the at least one filter value.

14. The non-transitory computer readable medium of claim 12, wherein the query filters the one or more items for the catalog based on a first filter representative of recently ordered items.

15. The non-transitory computer readable medium of claim 11, wherein the generating further comprises:
generating the catalog dynamically based on the at least one filter and the at least one filter value received at the mobile wireless device.

16. The non-transitory computer readable medium of claim 11, wherein the at least one filter comprises one or more of an account ID, a base catalog, a time frame, and a number of orders.

17. A system comprising:
at least one processor; and
at least one memory including instructions which when executed by the at least one processor provide operations comprising:
receiving, at a mobile wireless device, information including at least one filter and at least one filter value, wherein the at least one filter and the at least one filter value are selected at the mobile wireless device;
generating a catalog by at least filtering, based on at least the received information, one or more items for the catalog; and
presenting the generated catalog.

18. The system of claim 17, wherein the generating further comprises:
generating, based on the at least one filter and the at least one filter value, a query of a database, the database including the one or more items for the catalog.

19. The system of claim 17, wherein the query filters the one or more items for the catalog based on the at least one filter and the at least one filter value.

20. The system of claim 17, wherein the query filters the one or more items for the catalog based on a first filter representative of recently ordered items.
